(19) United States
(12) Patent Application Publication
(10) Pub. No.: US 2016/0044663 A1
(43) Pub. Date: Feb. 11, 2016

(54) Dynamic Uplink-Downlink Configuration

(71) Applicant: NOKIA SOLUTIONS AND NETWORKS OY, Espoo (FI)

(72) Inventors: Chun Hai YAO, Beijing (CN); Hai Peng LEI, Beijing (CN); Jie Zhen LIN, Beijing (CN); Kodo SHU, Beijing (CN); Juejia ZHOU, Beijing (CN)

(21) Appl. No.: 14/781,771

(22) PCT Filed: Apr. 3, 2013
(86) PCT No.: PCT/CN2013/073705

§ 371 Date: Oct. 1, 2015

(51) Int. Cl. H04W 72/04; H04L 5/00; H04L 1/16

(52) U.S. Cl. CPC H04W 72/0446; H04L 1/1671; H04L 5/0053

(57) ABSTRACT

A method and apparatus can be configured to determine an uplink-downlink configuration. The method also transmits an indication of the uplink-downlink configuration. The transmitting the indication of the uplink-downlink configuration includes using physical layer signaling. The transmitting the indication of the uplink-downlink configuration also includes reusing an existing physical layer channel. The transmitting the indication of the uplink-downlink configuration is performed without extending physical layer associations

### BACKGROUND

1. Field

Embodiments of the invention relate to signaling/indicating at least one uplink-downlink configuration.

2. Description of the Related Art

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

3GPP contribution R1-130422 discloses signaling mechanisms for time division duplex (TDD) uplink-downlink (UL-DL) reconfiguration. R1-130422 also discloses introducing a new physical channel to broadcast a TDD reconfiguration to all appropriate user equipment (UEs). R1-130422 also discloses using a physical downlink control channel (PDCCH) scrambled with new radio network temporary identities (RNTI), or reusing existing RNTI to indicate TDD reconfiguration.

3GPP contribution R1-130293 discloses signaling methods for TDD UL-DL reconfiguration. R1-130293 proposes using L1-based signaling as a baseline method for the TDD UL-DL reconfiguration.

3GPP contribution R1-130370 discloses using reconfiguration signaling and hybrid automatic repeat request timing (HARQ timing) for a TDD enhanced interference mitigation and traffic adaptation (eIMTA) system. A downlink control information (DCI) format 1C is used to transmit the reconfiguration signalling. Cyclic redundancy check (CRC) bits can be virtually extended in order to reduce the probability of false positive detections.

3GPP contribution R1-130532 describes physical (PHY) layer signaling considerations when performing dynamic TDD UL-DL reconfiguration. R1-130532 proposes that radio layer 1 (RAN1) should focus on PHY layer signaling. R1-130532 also evaluates impacts on physical downlink shared channel (PDSCH) scheduling and physical uplink shared channel (PUSCH) scheduling in a flexible subframe.

### SUMMARY

According to a first embodiment, a method can comprise determining an uplink-downlink configuration. The method can also comprise transmitting an indication of the uplink-downlink configuration. The transmitting the indication of the uplink-downlink configuration comprises using physical layer signaling. The transmitting the indication of the uplink-downlink configuration comprises reusing an existing physical layer channel. The transmitting the indication of the uplink-downlink configuration is performed without extending physical layer associations.

In the method of the first embodiment, reusing the existing physical layer channel comprises reusing an existing physical control format indicator channel.

In the method of the first embodiment, the transmitting the indication of the uplink-downlink configuration comprises indicating the uplink-downlink configuration using system information block signaling, and the uplink-downlink configuration is configuration 0.

In the method of the first embodiment, the transmitting the indication of the uplink-downlink configuration comprises reinterpreting a control format indicator.

In the method of the first embodiment, if a currently adopted uplink-downlink configuration is configuration 0, then a physical control format indicator channel is reused in one specific special subframe.

In the method of the first embodiment, if a currently adopted uplink-downlink configuration is one of configuration {1, 2, 3, 4, 5, 6}, then a physical control format indicator channel is reused in one specific downlink subframe.

According to a second embodiment, an apparatus can comprise at least one processor. The apparatus can also comprise at least one memory including computer program code. The at least one memory and the computer program code are configured, with the at least one processor, to cause the apparatus at least to determine an uplink-downlink configuration. The apparatus also transmits an indication of the uplink-downlink configuration. The transmitting the indication of the uplink-downlink configuration comprises using physical layer signaling. The transmitting the indication of the uplink-downlink configuration comprises reusing an existing physical layer channel. The transmitting the indication of the uplink-downlink configuration is performed without extending physical layer associations.

In the apparatus of the second embodiment, reusing the existing physical layer channel comprises reusing an existing physical control format indicator channel.

In the apparatus of the second embodiment, the transmitting the indication of the uplink-downlink configuration comprises indicating the uplink-downlink configuration using system information block signaling, and the uplink-downlink configuration is configuration 0.

In the apparatus of the second embodiment, the transmitting the indication of the uplink-downlink configuration comprises reinterpreting a control format indicator.

In the apparatus of the second embodiment, if a currently adopted uplink-downlink configuration is configuration 0, then a physical control format indicator channel is reused in one specific special subframe.

In the apparatus of the second embodiment, if a currently adopted uplink-downlink configuration is one of configuration {1, 2, 3, 4, 5, 6}, then a physical control format indicator channel is reused in one specific downlink subframe.

According to a third embodiment, a computer program product is embodied on a computer readable medium, the computer program product is configured to control a processor to perform a process comprising determining an uplink-downlink configuration. The process also comprises transmitting an indication of the uplink-downlink configuration. The transmitting the indication of the uplink-downlink configuration comprises using physical layer signaling. The transmitting the indication of the uplink-downlink configuration comprises reusing an existing physical layer channel. The transmitting the indication of the uplink-downlink configuration is performed without extending physical layer associations.

According to a fourth embodiment, a method comprises detecting an uplink-downlink configuration of at least one neighbor cell. The detecting the uplink-downlink configuration of the at least one neighbor cell is performed without using layered signaling. The method also comprises performing mitigation of interference based upon the detected uplink-downlink configuration.

In the method of the fourth embodiment, the detecting the uplink-downlink configuration of the at least one neighbor cell comprises choosing a special subframe configuration with a large guard period.

In the method of the fourth embodiment, the detecting the uplink-downlink configuration of the at least one neighbor cell comprises measuring a first set of cell-specific reference signal of the at least one neighbor cell within a guard period.

In the method of the fourth embodiment, the detecting the uplink-downlink configuration of the at least one neighbor cell comprises transmitting a second set of cell-specific reference signal within a guard period.

According to a fifth embodiment, an apparatus comprises at least one processor. The apparatus also comprises at least one memory including computer program code. The at least one memory and the computer program code are configured, with the at least one processor, to cause the apparatus at least to detect an uplink-downlink configuration of at least one neighbor cell. The detecting the uplink-downlink configuration of the at least one neighbor cell is performed without using layered signaling. The apparatus also performs mitigation of interference based upon the detected uplink-downlink configuration.

In the apparatus of the fifth embodiment, the detecting the uplink-downlink configuration of the at least one neighbor cell comprises choosing a special subframe configuration with a large guard period.

In the apparatus of the fifth embodiment, the detecting the uplink-downlink configuration of the at least one neighbor cell comprises measuring a first set of cell-specific reference signal of the at least one neighbor cell within a guard period.

In the apparatus of the fifth embodiment, the detecting the uplink-downlink configuration of the at least one neighbor cell comprises transmitting a second set of cell-specific reference signal within a guard period.

According to a sixth embodiment, a computer program product is embodied on a computer readable medium, the computer program product is configured to control a processor to perform a process. The process comprises detecting an uplink-downlink configuration of at least one neighbor cell, wherein the detecting the uplink-downlink configuration of the at least one neighbor cell is performed without using layered signaling. The process also comprises performing mitigation of interference based upon the detected uplink-downlink configuration.

### BRIEF DESCRIPTION OF THE DRAWINGS:

For proper understanding of the invention, reference should be made to the accompanying drawings, wherein:

FIG. 1 illustrates different kinds of time division duplex uplink-downlink configurations.

FIG. 2 illustrates control format indicator values in accordance with one embodiment.

FIG. 3 illustrates the process of indicating a configuration according to an embodiment.

FIG. 4 illustrates a special subframe configuration according to an embodiment.

FIG. 5 illustrates a mapping of a downlink reference signal in a special subframe according to an embodiment.

FIG. 6 illustrates another mapping of a downlink reference signal in a special subframe according to an embodiment.

FIG. 7 illustrates a flowchart of a method according to one embodiment.

FIG. 8 illustrates an apparatus according to an embodiment.

FIG. 9 illustrates an apparatus according to another embodiment.

FIG. 10 illustrates an apparatus according to another embodiment.

### DETAILED DESCRIPTION

One embodiment of the present invention relates to technologies implemented in accordance with 3rd Generation Partnership Project (3GPP) Long Term Evolution—Advanced (LTE-Advanced) Technology Release-12, with a focus on LTE Time Division Duplex (TDD) enhancement for downlink-uplink (DL-UL) interference management and traffic adaptation (TDD eIMTA).

Currently, TDD allows UL-DL allocations to be semi-statically configured based on a procedure that changes system information. The procedure that changes system information can have a corresponding time period, such as a 640 ms period. A TDD UL-DL configuration can be semi-statically configured via system information block 1 (SIB-1) signaling.

Although UL-DL allocations can be semi-statically configured, dynamic TDD UL-DL reconfiguration can be a desirable feature for traffic adaptation, particularly for traffic adaptation in small cells. As such, one embodiment is directed to supporting dynamic TDD UL-DL reconfiguration. Such dynamic reconfiguration can allow a TDD system to flexibly change a TDD UL-DL configuration to match variations in uplink and downlink traffic.

One embodiment dynamically configures/reconfigures UL-DL allocations by reusing existing physical layer uplink-downlink associations, such as a physical control format indicator channel (PCFICH) between an eNB and a UE. One embodiment reuses existing physical layer uplink-downlink associations to indicate/signal a TDD UL-DL configuration during TDD UL-DL reconfiguration. One embodiment reuses the physical layer associations without extending them.

In another embodiment, TDD UL-DL configuration/reconfiguration can be performed in conjunction with the detecting of uplink-downlink configurations of neighboring cells, without using layered signaling. In this embodiment, an evolved node B (eNB) can choose a special subframe configuration with a large guard period (GP). The embodiment can then perform selection of a first set of Orthogonal Frequency-Division Multiplexing Symbols (OSs) and a second set of OSs based on a current uplink-downlink configuration of the eNB. One embodiment can then transmit a cell-specific reference signal (CRS) in the first set of OSs within the GP. One embodiment can also monitor and measure a CRS of a neighboring cell in the second set of OSs within the GP, without layer-signaling assistance. One embodiment can then determine a neighbor cell's uplink-downlink configuration based on the detected neighbor cell's CRS transmission. One embodiment can also re-configure the current uplink-downlink configuration of the eNB based on the neighbor cell's uplink-downlink configurations.

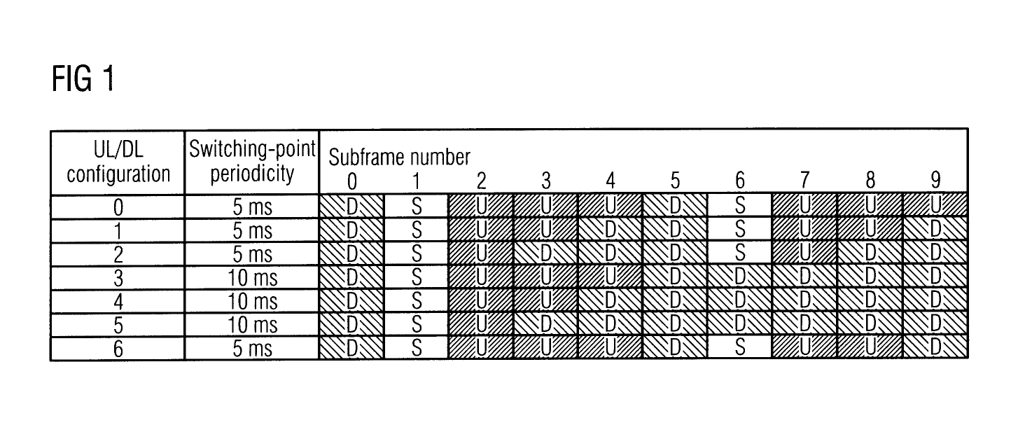

Currently, LTE TDD allows for asymmetric UL-DL allocations in accordance with a plurality of different semi-statically configured TDD UL-DL configurations. FIG. 1 illustrates different kinds of time division duplex uplink-downlink configurations. Specifically, FIG. 1 illustrates seven different semi-statically configured TDD UL-DL configurations. These allocations can provide between 40% and 90% of the subframes as DL subframes. Current mechanisms for implementing adaptive UL-DL allocation are based on a system information change procedure with a 640 ms period. TDD UL-DL configuration can be semi-statically indicated/signaled by SIB-1 signaling.

In one embodiment, an important objective of dynamic TDD UL-DL reconfiguration is to provide a signaling mechanism to signal/indicate a TDD UL-DL configuration (from an evolved Node B to a UE, for example), wherein the signaling mechanism is backwards compatible with older user equipment (UE).

Depending on an adaptation time scale, different methods for signaling/indicating a TDD UL-DL configuration change can be considered. Such methods include SIB signaling, Radio Resource Control (RRC) signaling, Medium Access Control (MAC) signaling, and physical layer signaling.

SIB signaling can be used to support a TDD UL-DL configuration indicated by the SIB. With a system information change procedure (in accordance with Release 8, for example), a supported time scale for TDD UL-DL reconfiguration is 640 ms or larger. A RRC signaling solution, whose typical time scale is on the order of 200 ms, may require one RRC message for indicating/signaling a TDD UL-DL configuration per active UE, unless a broadcast or a multicast approach is specified. A MAC signaling solution can support TDD UL-DL reconfiguration with a time scale of adaptation on the order of a few tens of milliseconds.

However, with these high-layer signaling methods, ambiguity can exist between an eNB and a UE relating to the TDD UL-DL configuration. The ambiguity may exist because the eNB may possibly not know the exact time at which the UE applies the updated TDD UL-DL configuration during a period of reconfiguration.

As such, physical layer signaling solutions can be used instead. With regard to physical layer signaling solutions, these solutions can support a TDD UL-DL reconfiguration with a 10 ms switching scale. The TDD UL-DL configuration can be explicitly signaled/indicated in a newly designed downlink control information (DCI) format in a common search space, or a UE-specific search space, or by means of a new physical layer channel. The introduction of a new DCI format or a new physical layer channel will not only generally increase the blind detection complexity of UE implementation but may also bring about a large standardization effort.

In view of the above, one embodiment can use physical layer signaling to signal/indicate a TDD UL-DL configuration (to a UE) in order to achieve a higher performance gain and in order to avoid ambiguity that may result during a reconfiguration period.

One embodiment of the present invention is directed to a method that signals/indicates a TDD UL-DL configuration (to a UE) by reusing an existing physical layer channel during TDD UL-DL reconfiguration. In one embodiment, a TDD UL-DL configuration can be signaled/indicated to a UE using SIB-1 signaling. For example, in one embodiment, a TDD UL-DL configuration (such as configuration 0, for example) can be indicated via SIB-1 signaling to a legacy UE. By indicating TDD UL/DL configuration 0 in SIB-1 signaling, one embodiment can avoid incorrect measurement of reference-signal-received power/channel-state information (RSRP/CSI), and can avoid incorrect PCFICH detection in a subframe (such as subframe 9, for example) by older UE. In one embodiment, a control format indicator (CFI) in a PCFICH can be reinterpreted so as to correspond to one specific TDD UL-DL configuration or a configuration change.

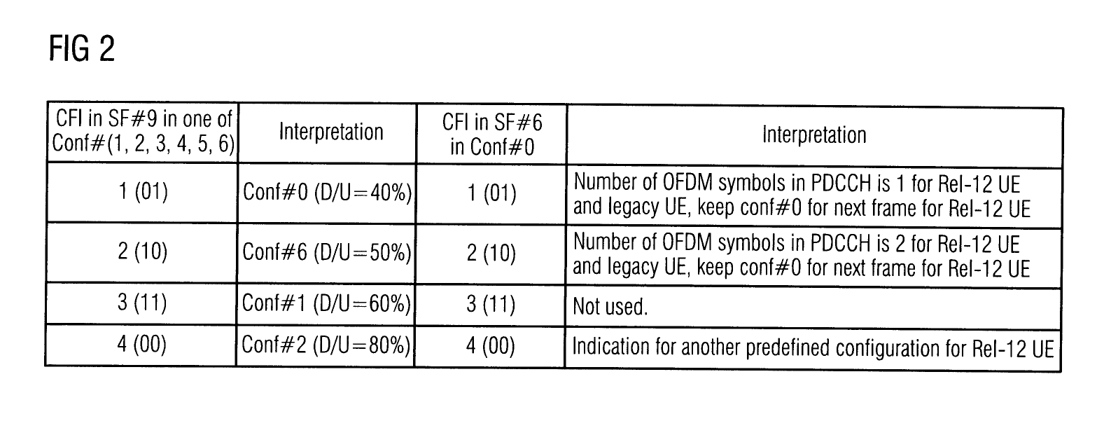

FIG. 2 illustrates, according to one embodiment, control format indicator (CFI) values in accordance with one embodiment. In one embodiment, the CFI values can be either specified in a 3GPP specification beforehand or be signaled/indicated to UEs via high-layer signaling. For a UE that operates in accordance with Release 12, if a currently-adopted TDD UL-DL configuration is one of TDD UL-DL configurations of the set {1, 2, 3, 4, 5, 6}, one embodiment reuses a PCFICH channel transmitted in one specific downlink subframe (for example, subframe 9) to indicate a subsequent specific TDD UL-DL configuration or a configuration change. If the currently-adopted TDD UL-DL configuration is one of the TDD UL-DL configurations of the set {1, 2, 3, 4, 5, 6}, the number of OFDM symbols (OSs) in a physical downlink control channel (PDCCH), in the downlink subframe transmitting the TDD UL-DL configuration by PCFICH, is predefined to a fixed size or a size that is the same as a CFI value indicated in a last non-special subframe. The size can also be indicated by high-layer signaling. If the currently-adopted TDD UL-DL configuration is a specific configuration (such as configuration 0, for example), one embodiment can reuse a PCFICH channel in one specific special subframe (for example, subframe 6) to directly signal/indicate (to the UE) one specific TDD UL-DL configuration or a configuration change. If the currently-adopted TDD UL-DL configuration is configuration 0, to guarantee backwards compatibility with legacy UEs, a CFI in the PCFICH in the specific special subframe can be used not only to indicate a number of practical OFDM symbols configured for PDCCH, but also indicate a TDD UL-DL configuration kept for configuration 0 (or another configuration which has been changed to).

In one embodiment, the above-described functionality for indicating the TDD UL-DL configuration is achieved without introducing any new DCI format nor any new physical layer channel.

As described above, in LTE TDD, seven TDD UL-DL configurations have been specified since Release 8. These configurations can provide between 40% and 90% of subframes as DL subframes. However, some configurations can provide a similar DL/UL ratio with respect to other configurations. For example, referring again to FIG. 1, both TDD UL-DL configuration 2 and 4 can provide a DL/UL ratio of about 80%. On the other hand, if all seven TDD UL-DL configurations are dynamically selected for reconfiguration, then a hybrid automatic repeat request (HARQ) timing in DL (or UL) and a PUSCH transmission (or retransmission) timing may be complicated when one TDD UL-DL configuration is changed to another configuration with different switching points. On the other hand, if this set is limited for TDD UL-DL configurations with a switching point (such as a 5 ms switching point), then HARQ timing issues may be simplified.

The PCFICH can indicate the size of a control region in terms of a number of orthogonal frequency-division multiplexing (OFDM) symbols. The PCFICH can indicate where a data region starts in a subframe. Correct decoding of the PCFICH information can be essential. If the PCFICH is incorrectly decoded, it is possible that the UE/terminal will neither know how to process the control channels nor where the data region starts for the corresponding subframe.

The PCFICH can comprise two bits of information, which are used to differentiate between three different control-region sizes of one OFDM symbol, two symbols, or three symbols (the sizes may be two, three, or four symbols for narrow bandwidths), which are coded into a 32-bit codeword. The coded bits can be scrambled with a cell-specific and/or subframe-specific scrambling code to randomize inter-cell interference, can be quadrature phase shift keying (QPSK) modulated, and can be mapped to 16 resource elements. As the size of the control region is generally unknown until the PCFICH is decoded, the PCFICH is generally mapped to the first OFDM symbol of each subframe.

The mapping of the PCFICH to resource elements in the first OFDM symbol in the subframe can be done in groups of four resource elements, with the four groups being well separated in frequency to obtain good diversity. Furthermore, to avoid collisions between PCFICH transmissions in neighboring cells, the location of the four groups in the frequency domain can depend on the physical-layer cell identity.

Therefore, the reliability of PCFICH can be high, especially in pico-cells or femto-cells with small coverage. The reliability can be high enough to reuse PCFICH for TDD UL-DL configuration indication.

As previously described, certain embodiments are backwards compatible with legacy UEs when performing the above-described functionality during dynamic TDD UL-DL reconfiguration. In current TDD LTE/LTE-A systems, the TDD UL-DL configuration can be broadcast via SIB1 signaling. A minimum SIB1 modification period can be 640 ms, for example. Shorter timescales for reconfiguration can be shown to improve performance. Faster TDD configuration indication mechanisms can be needed to implement dynamic TDD UL-DL reconfiguration in order to achieve improved performance when adapting to traffic. However, when performing fast TDD reconfiguration the embodiments may need to determine whether the fast reconfiguration is backwards compatible to legacy UEs. For example, UEs operating according to Release 8 may be unaware/unable to accommodate the faster reconfiguration.

For an older/legacy UE, there is generally no problem if a subframe that is indicated as an UL subframe in SIB1 is changed to a DL subframe by reconfiguration, provided that the eNB takes care of the UL scheduling and control signaling configuration appropriately. However, if a DL subframe indicated by SIB1 is changed to an UL subframe by dynamic reconfiguration, the legacy UE will generally suffer from inaccurate radio-link monitoring/radio-resource monitoring (RLM/RRM), inaccurate channel quality indicator (CQI) measurement, and inaccurate channel tracking as a result of there being no CRS/CSI-RS transmission in the changed UL subframes.

Because a subframe-restricted measurement was introduced for Release 10 enhanced inter-cell interference coordination (eICIC), enabling backwards compatibility with Release 10 UE can be partly addressed by configuring the consistent DL subframes (for example, subframe 0, 1, 5, and 6) to be the measurement subframes for CSI and RLM measurement.

Therefore, in consideration of the need for backwards compatibility with older/legacy UEs, one embodiment uses a specific TDD UL-DL configuration as a SIB1-delivered configuration. For example, one embodiment can use TDD UL-DL configuration 0 as the SIB1-delivered configuration. In this way, legacy UE can perform CSI/RLM/RRM measurements in fixed downlink subframes (for example, subframes 0, 1, 5, or 6). So, one embodiment can avoid wrong measurements.

Referring again to FIG. 1, in one embodiment, subframe 9 of a TDD UL-DL configuration of {1, 2, 3, 4, 5, 6} can be used for downlink transmission. In this embodiment, a legacy UE may not be able to detect the downlink channel (a downlink channel in subframe 9, for example). Therefore, in order to ensure backwards compatibility with the legacy UE, one embodiment reuses a PCFICH channel transmitted in downlink subframe 9 to directly indicate a TDD UL-DL configuration or a configuration change, if a currently adopted TDD UL-DL configuration is one of the TDD UL-DL configurations {1, 2, 3, 4, 5, 6}. Regarding the number of OFDM symbols in PDCCH in subframe 9, the number can be predefined to a fixed size (for example, three OFDM symbols for a PDCCH) or to a size corresponding to the CFI indicated in the last non-special subframe, or a size indicated by high-layer signaling.

As such, the CFI value carried by PCFICH can be reinterpreted in accordance with FIG. 2, for example. For example, the four TDD UL-DL configurations with a 5 ms switching point can be explicitly indicated by a PCFICH channel without ambiguity during reconfiguration. Alternatively, a CFI value can also be used to indicate configuration change, for example. In one embodiment, a current configuration number can added to, can be subtracted from, or can be kept unchanged. Other mapping relations can also be supported by reinterpreting the four statuses of the CFI value.

Referring again to FIG. 1, if a current TDD UL-DL configuration is configuration 0, subframe 9 can be used for uplink. As such, PCFICH may not be available in that subframe. One embodiment uses a PCFICH channel in a special subframe, in configuration 0, to indicate the TDD UL-DL configuration. Because a special subframe is generally also able to be detected by a legacy UE, PCFICH in that subframe should be used to indicate the number of OFDM symbols of PDCCH. A number of OFDM symbols configured for PDCCH in the special subframe can be 1 or 2 according to TS 36.211. As such, in this scenario, a CFI value is generally not indicated to be 3 in the special subframe.

In view of the above, one embodiment reinterprets the status of a PCFICH transmitted in a special subframe (subframe 6, for example) when the TDD UL-DL configuration is configuration 0, as shown in FIG. 2. Specifically, if a detected CFI value in that subframe is 1 or 2, then the number of OFDM symbols configured for the PDCCH is 1 or 2. Then, both legacy UEs and Release 12 UEs will generally be able to determine the PDCCH region and the starting symbol of the PDSCH. Further, one embodiment also indicates that current TDD UL-DL configuration 0 is kept for a next frame for a Release 12 UE. If the detected CFI value in that subframe is 4, then both legacy UEs and Release 12 UEs will generally follow the PDCCH region as indicated by a previous special subframe. For example, the UE's may determine the PDCCH region as indicated by PCFICH in DL subframe 1, which is also a special subframe. Additional information provided for Release 12 UEs is the predefined TDD UL-DL configuration that shall be used in a next frame.

Because TDD UL-DL configuration 0 has a DL ratio of 40%, TDD UL-DL configuration 6 can be a predefined configuration to provide a 50% DL ratio. If more DL resources are needed for DL-favored traffic, a more DL-heavy configuration can be indicated by reusing PCFICH in Subframe 9 of a next frame. Of course, TDD UL-DL configuration 1 or 2 can also be a predefined configuration to provide 60% or 80% DL resources. The predefined configuration can be specified by the 3GPP specification. The predefined configuration can also be indicated to the Release 12 UEs via high-layer signaling.

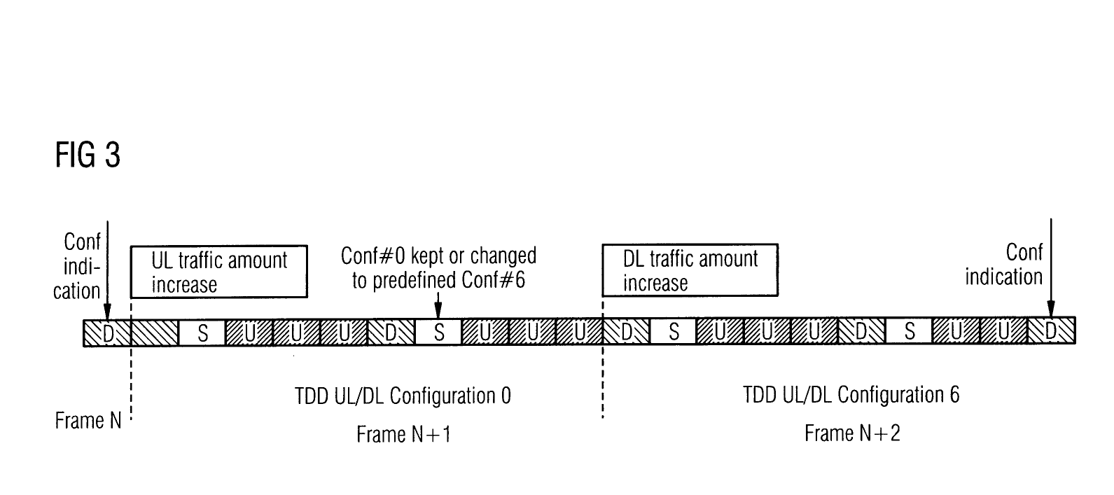

FIG. 3 illustrates the process of indicating a configuration according to an embodiment. First, assume that a TDD UL-DL configuration X in Frame N has been signaled/indicated to a legacy UE using SIB-1 signaling. Here, X can be considered to be a configuration corresponding to one of TDD UL-DL configurations {1, 2, 3, 4, 5, 6}. TDD UL-DL configuration 0 can be indicated via SIB-1 signaling to a legacy UE. The legacy UE can perform CSI/RLM/RRM measurements in fixed downlink subframes. For example, the legacy UE can perform measurements in subframes 0, 1, 5, or 6, and the eNB can avoid scheduling a UE's uplink transmission in a flexible subframe, if that subframe is for downlink.

Second, for an eNB to adapt to traffic variation in its cell, the eNB can decide to adopt TDD UL-DL configuration Y. Here, Y can be a configuration of the configuration set {0, 1, 2, 6}, for example. The set can be defined by an operator as well.

Third, at frame N, the eNB can indicate a determined TDD UL-DL configuration (configuration Y) to the UE, by means of reusing a PCFICH channel in subframe 9. The corresponding mapping relationship can be specified in FIG. 3 by one status of CFI in PCFICH. The number of OFDM symbols of PDCCH in subframe 9 can be the same as the CFI transmitted in the previous non-special subframe.

Fourth, at frame N+1, TDD UL-DL configuration Y can be adopted. If Y is one of TDD UL-DL configuration {1, 2, 6}, and there is a need for a configuration change for a future frame (e.g. Frame N+2 or Frame N+n), an eNB can indicate the determined TDD UL-DL configuration to Release-12 UEs by using PCFICH in subframe 9, as described in the third step above. However, if configuration Y is configuration 0, as subframe 9 is an UL subframe in configuration 0, the eNB can indicate the determined TDD UL-DL configuration to Release 12 UEs by means of reusing PCFICH in subframe 6. The corresponding mapping relationship is specified in FIG. 2 by reinterpreting a CFI value. If TDD UL-DL configuration 0 is still adopted for a next frame (Frame N+2, for example), then a CFI value shall be indicated according to the real number of OFDM symbols configured for PDCCH. Otherwise, the CFI value of 4 will be indicated. As an example, a CFI value of 4 can indicate configuration 6. However, a CFI value of 4 can be also set to indicate configurations 1 and/or 2.

Fifth, the eNB can decide to adopt the proper configuration to adapt to the traffic variation.

In view of the above, one embodiment provides benefits as a result of using dynamic TDD UL-DL reconfiguration. In one embodiment, no new DCI format is introduced. Embodiments can provide a reliable TDD UL-DL configuration indication. Embodiments can also provide explicit TDD UL-DL configuration indication for a UE. Embodiments can also avoid ambiguity problems during TDD UL-DL reconfiguration.

Next, if eNB flexible UL-DL re-configuration is enabled, an interference situation may occur. For example, interference may occur between different eNBs (i.e., eNB-eNB interference). If a plurality of small cells exist, each small cell could possibly freely change its UL-DL configuration across different radio frames. As such, referring again to FIG. 1, interference may occur in the flexible subframes (e.g., subframes 3, 4, 7, 8, 9). If a small cell is switched on/off frequently based on the traffic fluctuation in uplink and downlink, then an eNB measurement can be helpful to mitigate interference in a real time manner. eNB measurement can be used in scheduling dependent interference mitigation and cell cluster interference mitigation schemes, which have been described in 3GPP Specification TR 36.828.

Release 10 defines certain femto eNB power setting requirements. When a femto eNB is powered on, the femto eNB can monitor the strength of CRS signaling from neighbouring macro cells, and then decide its own transmission power, as described in section 6.2.5 in TS 36.104 Release 10.

One embodiment is directed to a method of enabling eNB-eNB interference measurement by using existing physical layer signals for dynamic TDD UL-DL reconfiguration.

In one embodiment, an eNB chooses a special subframe configuration with a large guard period (GP), transmits CRS and/or monitors neighboring cell CRS in the GP, and then fulfills inter-eNB measurements and obtains a neighboring cell's UL-DL configuration for further UL-DL interference mitigation.

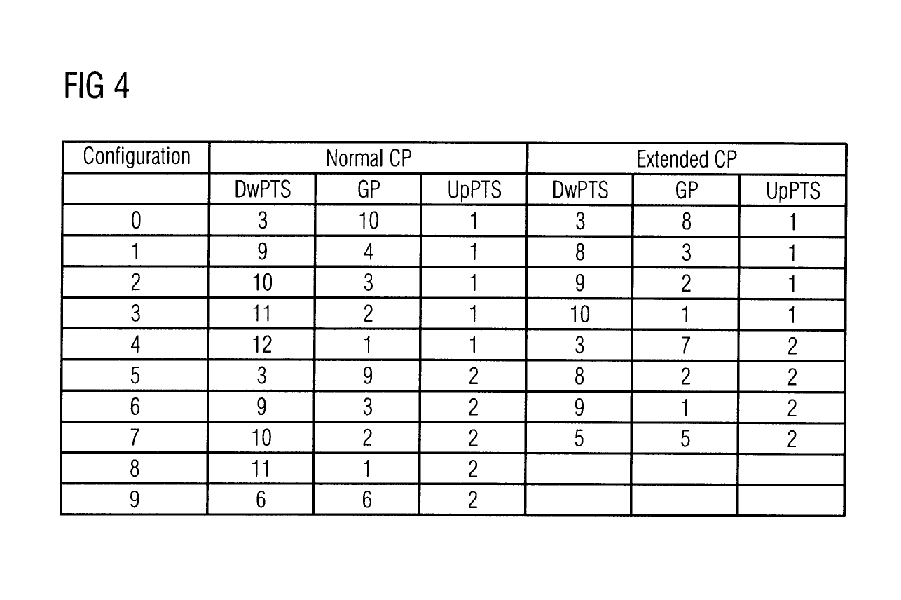

FIG. 4 illustrates a special subframe configuration according to an embodiment. For each special subframe configuration, each special subframe configuration specifies a downlink pilot time slot (DwPTS) and an uplink pilot time slot (UpPTS). In a first embodiment, if SIB 1 indicates a special subframe configuration is configuration #0 {3,10,1}, then a CRS is normally sent in OFDM Symbol (OS) #0 in a special subframe, and an eNB could change to a listening mode to detect other cells' CRS in OS #4, 7, 11, or transmit CRS in these OSs according to the parameters below:
If an eNB UL-DL re-configuration is limited to a 5 ms switching periodicity, an eNB could transmit its own cell CRS in OS #4, 7, 11 in special subframe #1 according to its own UL-DL configuration adopted in the current radio frame.
   If the current UL-DL configuration is 0, no additional CRS is generally transmitted, and the eNB monitors neighboring cells' CRS in OS #4, 7, 11.
   If the current UL-DL configuration is 1, a CRS in OS #4 can be transmitted, and the eNB can monitor neighboring cells CRS' in OS #7, 11
   If the current UL-DL configuration is 2, a CRS in OS #7 can be transmitted, and the eNB can monitor neighboring cells' CRS in OS #4, 11
   If the current UL-DL configuration is 6, a CRS in OS #11 can be transmitted, and the eNB can monitor neighboring cells CRS in OS #4, 7
If an eNB UL-DL re-configuration can be dynamically selected in all existing 7 UL-DL configurations, extended eNB measurements can behave as described below based on the above measurement behaviors.
   An eNB with a UL-DL configuration that is one of the TDD UL-DL configurations {0, 1, 2, 6} can further monitor neighboring cells' CRS in OS #4, 7, 11 in special subframe #6. If an eNB receives a neighboring cell's CRS in these symbols, the neighboring cell configuration can be derived.
   Alternatively, an eNB with a UL-DL configuration that is one of TDD UL-DL configurations {3, 4, 5} can reconfigure the CRS transmission in OS #4, 7, 11 in subframe #6 according to its own UL-DL configuration in a current radio frame
   If an eNB's current UL-DL configuration is 3, CRS in OS #0, 7, 11 in subframe #6 can be transmitted, or CRS in OS#0, 4 can be transmitted.
   If an eNB's current UL-DL configuration is 4, CRS in OS #0, 4, 11 in subframe #6 can be transmitted, or CRS in OS #0, 7 can be transmitted.
   If an eNB's current UL-DL configuration is 5,CRS in OS #0, 4, 7 in subframe #6 can be transmitted, or CRS in OS #0, 11 can be transmitted.
   After detecting a neighboring cell's CRS transmission patterns in specific OSs, an eNB can determine the UL-DL configuration of the neighboring cell.

In a second embodiment, a same eNB CRS measurement as the first embodiment, the eNB differentiates the 7 UL-DL configuration through two radio frame measurements. If SIB 1 has indicated the special subframe configuration is configuration#0 {3,10,1}, then CRS is normally sent in OFDM Symbol (OS) #0 in a special subframe, the eNB could change to listening mode to detect other cells' CRS in OS #4, 7, 11 or transmit CRS in these OSs according to the parameters below:
An eNB could transmit its own cell's CRS in OS #4, 7, 11 in special subframe #1 according to its own UL-DL configuration adopted in the current radio frame:
If a current UL-DL configuration is 0, no additional CRS is generally transmitted, and the eNB can monitor neighboring cells' CRS in OS #4, 7, 11
in an even radio frame,
   If a current UL-DL configuration is 1, CRS in OS #4 can be transmitted, and the eNB can monitor neighboring cells' CRS in OS #7, 11
   If a current UL-DL configuration is 2, CRS in OS #7 can be transmitted, and the eNB can monitor neighboring cells' CRS in OS #4, 11
   If a current UL-DL configuration is 6, CRS in OS #11 can be transmitted, and the eNB can monitor neighboring cells' CRS in OS #4, 7
in odd radio frame,
   If a current UL-DL configuration is 3, CRS in OS #4 can be transmitted, and the eNB can monitor neighboring cells' CRS in OS #7, 11
   If a current UL-DL configuration is 4, CRS in OS #7 can be transmitted, and the eNB can monitor neighboring cells' CRS in OS #4, 11
   If a current UL-DL configuration is 5, CRS in OS #11 can be transmitted, and the eNB can monitor neighboring cells' CRS in OS #4, 7
Also, for both the first and second scenarios, when UL-DL re-configuration occurs for only two UL-DL configurations, such as configuration #0 and 2, configuration #0 and 5, refer to the below parameters (taking configuration #0 and 5), for example,
   An eNB with a UL-DL configuration that is configuration #0 generally monitors neighboring cells' CRS in OS #4, 7, 11, and no CRS in OS #4, 7, 11 will be transmitted; an eNB with a UL-DL configuration that is configuration #5 will generally transmit CRS in OS #4, 7, 11.
   In one alternative, the eNB with UL-DL configuration #0 generally only monitors neighboring cells CRS in OS #7, 11 and transmits additional CRS in OS #4; eNB with UL-DL configuration #5 will generally transmit CRS in OS #7, 11 and monitor neighboring cells' CRS in OS #4; or, the eNB with UL-DL configuration #0 will generally only monitor neighboring cell CRS in OS #4, 7, 11 in special subframe #6 and transmit CRS in OS #0, 4, 7, 11 in special subframe #1; while eNB with UL-DL configuration #5 will monitor CRS in OS #4, 7, 11 in special subframe #1 and transmit CRS in OS #0, 4, 7, 11 in subframe #6.
   In one embodiment, a UE monitors CRS in a subframe which is not scheduled to be a UL nor a DL grant. The CRS is decoded to get the neighboring cell UL-DL configuration.
In one embodiment, an eNB can determine its neighboring cells' UL-DL configuration through the measurement on CRS in special subframe(s). The embodiment also gets the interference level and the path loss between two cells.
The above-described methods can be used in conjunction with a normal CP. Similar principles can apply for an extended CP.

According to the Home evolved Node B (HeNB) power setting requirements of Release 10, a HeNB has the capability to measure a reference signal received power (RSRP) of a macro eNB when the HeNB is powered on.

FIG. 5 illustrates a mapping of a downlink reference signal in a special subframe according to an embodiment. It can be seen from FIG. 5 that a CRS will occupy OS #0, 4, 7, 11 with normal cyclic prefix case. If an eNB configured with special subframe configuration #0 {3, 10, 1} (as shown in FIG. 4), the CRS will generally be transmitted in a first OS. Then after the first 3 OS transmissions, the eNB can change to a receiving mode to monitor other eNB's CRS. Note that, based on Release 8 GP design, the UL to DL and DL to UL transition time is smaller than 20 us, and one OS occupies approximately 71 us.

In one embodiment, all flexible TDD UL-DL configuration eNBs configure their special subframe configurations as configuration #0, if the UL-DL reconfiguration is limited to configurations 0, 1, 2, 6. So, if a current UL-DL configuration is configuration 0, in special subframe #1, the eNB is configured with a special subframe configuration #0, and generally only transmits CRS in OS #0. The eNB monitors neighbouring cells' CRS in OS #4, 7, 11, which could be used by other eNBs transmitting CRS. If a current UL-DL configuration is configuration 1, the eNB will generally transmit CRS in OS #0, 4, and listen to other cells' CRS in OS #7 and 11; if a current UL-DL configuration is 2, the eNB will transmit CRS in OS #0, 7, and listen to other cells' CRS in OS #4 and 11; if a current UL-DL configuration is 6, the eNB will transmit CRS in OS #0, 11, and listen to other cells' CRS in OS #4 and 7. So, CRS will be transmitted in different CRS OS with different UL-DL configurations. After receiving a neighbouring cell's CRS in a specific OS, the eNB can determine the neighbouring cell's UL-DL configuration, the neighbouring cell's path loss and interference level. Then, interference mitigation schemes could be used to reduce the interference, such as reducing the DL transmission power in a conflicting subframe or scheduling users in non-conflicting subframes, and so on.

If the current seven UL-DL re-configurations can be applied, the eNB configured with a second special subframe could measure neighbouring cells' CRS in OS#4, 7, 11, and then know that the related UL-DL configuration could be 3, 4, 5. An eNB configured with UL-DL configuration #3, 4, 5 could reduce one column of CRS transmission in OS #4, 7, 11 in subframe 6, then the eNB could distinguish the specific UL-DL configuration from configurations #3, 4, 5.

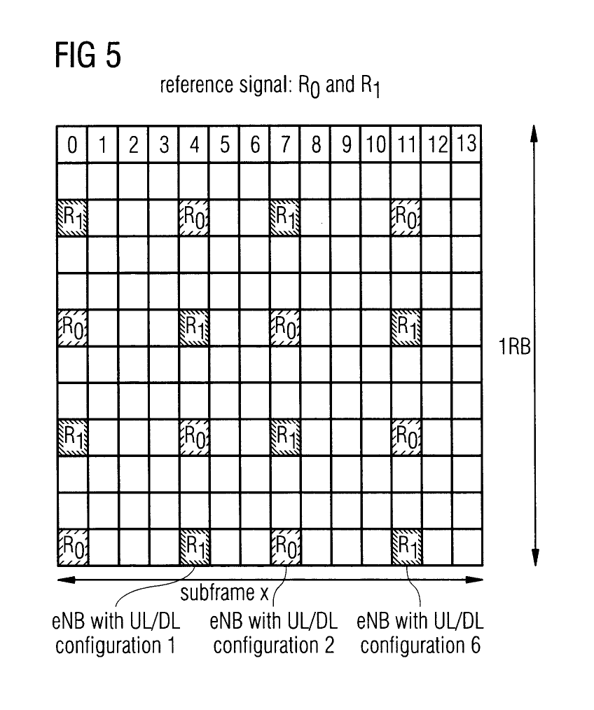

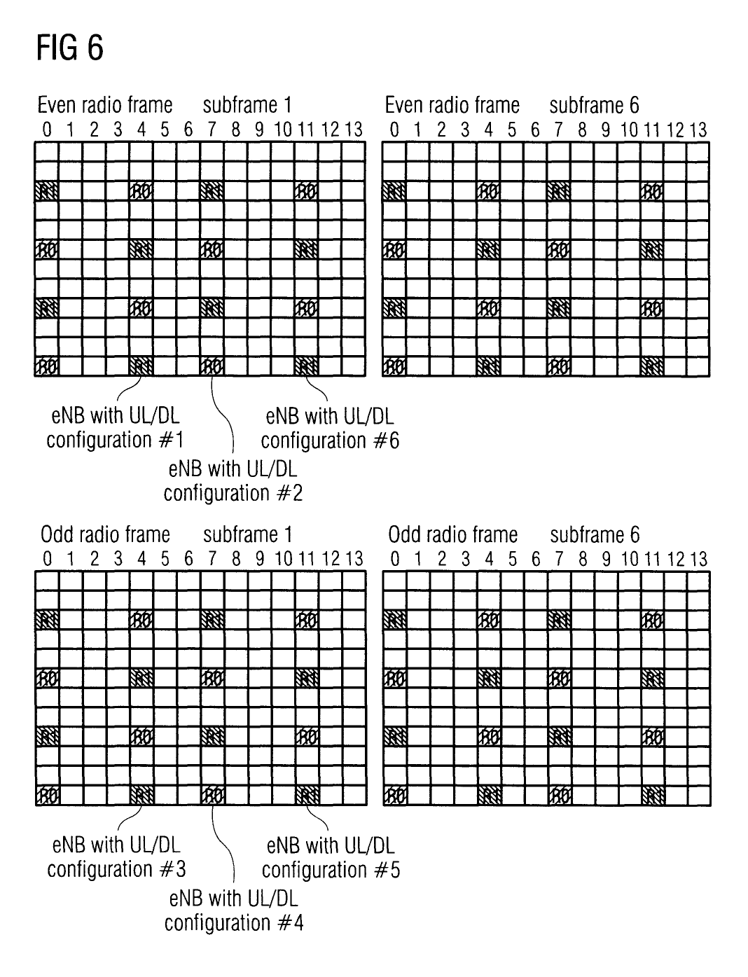

The general principles of eNB measurement are shown in FIG. 6, comparing a first embodiment, as described above, with a second embodiment, as also described above. FIG. 6 illustrates another mapping of a downlink reference signal in a special subframe according to an embodiment. The second embodiment uses another radio frame to perform the eNB CRS measurement. For example, the eNB measurement can be performed in an odd radio frame. Then the eNB does not need to do CRS measurement on subframe #6 to get the UL-DL configurations of 3, 4, 5, also, an eNB configured with UL-DL configuration #3, 4, 5 could differentiate from each other through CRS measurement.

In view of the above, one embodiment measures neighbouring cell interference without introducing any new physical signal. One embodiment can obtain a neighbouring cell's UL-DL configuration via measurements without physical layer/MAC layer/higher-layer-signaling assistance. One embodiment can apply the above-described method to cell clustering and schedules dependent interference mitigation schemes, as mentioned in TR 36.828.

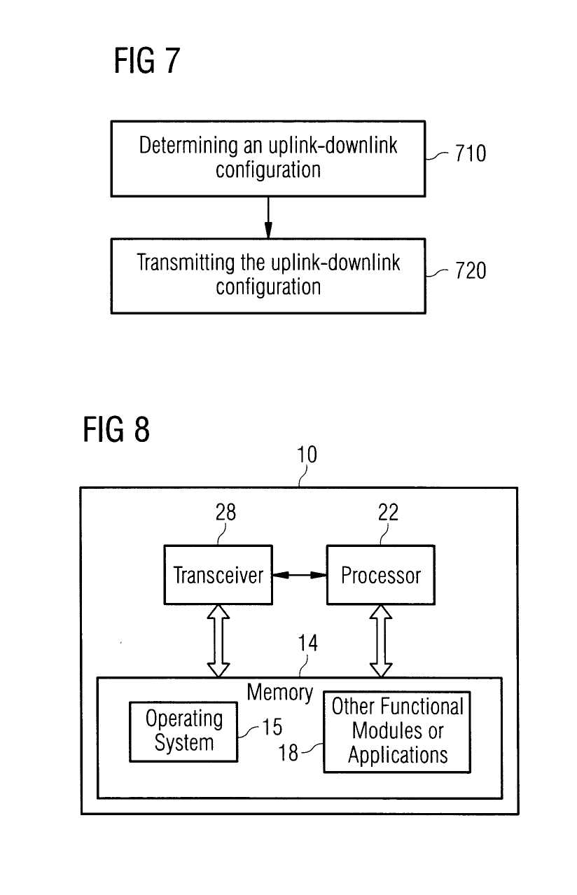

FIG. 7 illustrates a logic flow diagram of a method according to an embodiment. The method illustrated in FIG. 7 includes, at 710, determining an uplink-downlink configuration. At 720, one embodiment transmits an indication of the uplink-downlink configuration. The transmitting the indication of the uplink-downlink configuration comprises using physical layer signaling. The transmitting the indication of the uplink-downlink configuration comprises reusing an existing physical layer channel. The transmitting the indication of the uplink-downlink configuration is performed without extending physical layer associations.

FIG. 8 illustrates an apparatus 10 according to another embodiment. In an embodiment, apparatus 10 can be a transmitting device, such as an eNB, for example.

Apparatus 10 can include a processor 22 for processing information and executing instructions or operations. Processor 22 can be any type of general or specific purpose processor. While a single processor 22 is shown in FIG. 8, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

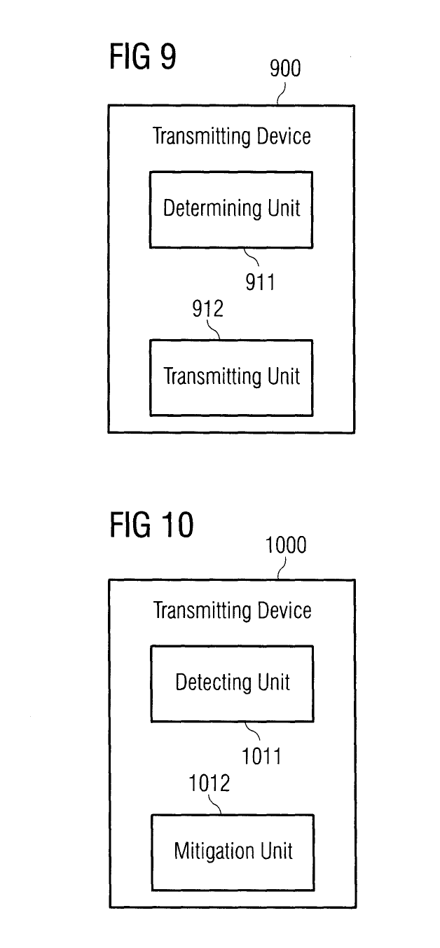

FIG. 9 illustrates an apparatus 900 according to another embodiment. In an embodiment, apparatus 900 can be a transmitting device. Apparatus 900 can include a determining unit 911 that determines an uplink-downlink configuration. Apparatus 900 can also include a transmitting unit 912 that transmits an indication of the uplink-downlink configuration. The transmitting the indication of the uplink-downlink configuration comprises using physical layer signaling. The transmitting the indication of the uplink-downlink configuration comprises reusing an existing physical layer channel. The transmitting the indication of the uplink-downlink configuration is performed without extending physical layer associations.

FIG. 10 illustrates an apparatus 1000 according to another embodiment. In an embodiment, apparatus 1000 can be a transmitting device. Apparatus 1000 can also include a detecting unit 1011 that detects an uplink-downlink configuration of at least one neighbor cell. The detecting the uplink-downlink configuration of the at least one neighbor cell can be performed without using layered signaling. Apparatus 1000 can also include a performing mitigation unit 1012 that performs mitigation of interference based upon the detected uplink-downlink configuration.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A method, comprising:
determining an uplink-downlink configuration; and
transmitting an indication of the uplink-downlink configuration, wherein
the transmitting the indication of the uplink-downlink configuration comprises using physical layer signaling,
the transmitting the indication of the uplink-downlink configuration comprises reusing an existing physical layer channel, and
the transmitting the indication of the uplink-downlink configuration is performed without extending physical layer associations.

2. The method according to claim 1, wherein reusing the existing physical layer channel comprises reusing an existing physical control format indicator channel.

3. The method according to claim 1 or 2, wherein the transmitting the indication of the uplink-downlink configuration comprises indicating the uplink-downlink configuration using system information block signaling, and the uplink-downlink configuration is configuration 0.

4. The method according to claim 1, wherein the transmitting the indication of the uplink-downlink configuration comprises reinterpreting a control format indicator.

5. The method according to claim 1, wherein, if a currently adopted uplink-downlink configuration is configuration 0, then a physical control format indicator channel is reused in one specific special subframe.

6. The method according to claim 1, wherein, if a currently adopted uplink-downlink configuration is one of configuration {1 , 2, 3, 4, 5, 6}, then a physical control format indicator channel is reused in one specific downlink subframe.

7. An apparatus, comprising:
at least one processor; and
at least one memory including computer program code,
the at least one memory and the computer program code configured, with the at least one processor, to cause the apparatus at least to
determine an uplink-downlink configuration; and
transmit an indication of the uplink-downlink configuration, wherein
the transmitting the indication of the uplink-downlink configuration comprises using physical layer signaling,
the transmitting the indication of the uplink-downlink configuration comprises reusing an existing physical layer channel, and
the transmitting the indication of the uplink-downlink configuration is performed without extending physical layer associations.

8. The apparatus according to claim 7, wherein reusing the existing physical layer channel comprises reusing an existing physical control format indicator channel.

9. The apparatus according to claim 7, wherein the transmitting the indication of the uplink-downlink configuration comprises indicating the uplink-downlink configuration using system information block signaling, and the uplink-downlink configuration is configuration 0.

10. The apparatus according to claim 7, wherein the transmitting the indication of the uplink-downlink configuration comprises reinterpreting a control format indicator.

11. The apparatus according to claim 7, wherein, if a currently adopted uplink-downlink configuration is configuration 0, then a physical control format indicator channel is reused in one specific special subframe.

12. The apparatus according to claim 7, wherein, if a currently adopted uplink-downlink configuration is one of configuration {1, 2, 3, 4, 5, 6}, then a physical control format indicator channel is reused in one specific downlink subframe.

13. (canceled)

14. A method, comprising:
detecting an uplink-downlink configuration of at least one neighbor cell, wherein the detecting the uplink-downlink configuration of the at least one neighbor cell is performed without using layered signaling; and
performing mitigation of interference based upon the detected uplink-downlink configuration.

15. The method according to claim 14, wherein the detecting the uplink-downlink configuration of the at least one neighbor cell comprises choosing a special subframe configuration with a large guard period.

16. The method according to claim 14, wherein the detecting the uplink-downlink configuration of the at least one neighbor cell comprises measuring a first set of cell-specific reference signal of the at least one neighbor cell within a guard period.

17. The method according to claim 14, wherein the detecting the uplink-downlink configuration of the at least one neighbor cell comprises transmitting a second set of cell-specific reference signal within a guard period.

18. An apparatus, comprising:
at least one processor; and
at least one memory including computer program code,
the at least one memory and the computer program code configured, with the at least one processor, to cause the apparatus at least to
detect an uplink-downlink configuration of at least one neighbor cell, wherein the detecting the uplink-downlink configuration of the at least one neighbor cell is performed without using layered signaling; and
perform mitigation of interference based upon the detected uplink-downlink configuration.

19. The apparatus according to claim 18, wherein the detecting the uplink-downlink configuration of the at least one neighbor cell comprises choosing a special subframe configuration with a large guard period.

20. The apparatus according to claim 18, wherein the detecting the uplink-downlink configuration of the at least one neighbor cell comprises measuring a first set of cell-specific reference signal of the at least one neighbor cell within a guard period.

21. The apparatus according to claim 18, wherein the detecting the uplink-downlink configuration of the at least one neighbor cell comprises transmitting a second set of cell-specific reference signal within a guard period.

22. (canceled)
